(19) United States
(12) Patent Application Publication
(10) Pub. No.: US 2021/0158623 A1
(43) Pub. Date: May 27, 2021

(54) INFORMATION PROCESSING DEVICE, INFORMATION PROCESSING METHOD, INFORMATION PROCESSING PROGRAM

(71) Applicant: SONY CORPORATION, TOKYO (JP)

(72) Inventor: NORIYUKI SUZUKI, CHIBA (JP)

(21) Appl. No.: 17/046,985

(22) PCT Filed: Mar. 1, 2019
(86) PCT No.: PCT/JP2019/008067

§ 371 Date: Oct. 12, 2020

(30) Foreign Application Priority Data
Apr. 25, 2018 (JP) 2018-083603

(51) Int. Cl. G06T 19/00

(52) U.S. Cl. CPC G06T 19/006

(57) ABSTRACT

An information processing device acquires first information from a detection device attached to a real object, acquires second information from a display device, places a virtual object corresponding to the first information and a virtual camera corresponding to the second information in a virtual space, and transmits information on the virtual space to the display device.

### TECHNICAL FIELD

The present technique relates to an information processing device, an information processing method, and an information processing program.

### BACKGROUND ART

In recent years, a technique for virtually enhancing the world in front of the eye has attracted attention, which is called augmented reality (AR) in which a virtual object such as CG (Computer Graphics) and/or visual information are overlaid and displayed on a real-world landscape, and various proposals using AR have been made (PTL 1).

### CITATION LIST

### Patent Literature

### [PTL 1]

### JP 2012-155654A

### SUMMARY

### Technical Problem

In AR, a mark called “marker” is usually used, and when the user recognizes the position of the marker and then captures an image of the marker with a camera of an AR device such as a smartphone, a virtual object and/or visual information are overlaid and displayed on a live image captured by the camera of the smartphone.

In this method, the virtual object and/or the visual information are not displayed on the AR device unless the image of the marker is captured by the camera of the AR device, so that there is a problem that the use environment and the use application are limited.

The present technique has been made in view of such problems, and an object thereof is to provide an information processing device, an information processing method, and an information processing program capable of displaying a virtual object without recognizing the position of a mark such as a marker.

### Solution to Problem

In order to solve the above-described problem, a first technique is an information processing device that acquires first information from a detection device attached to a real object, acquires second information from a display device, places a virtual object corresponding to the first information and a virtual camera corresponding to the second information in a virtual space, and transmits information on the virtual space to the display device.

Further, a second technique is an information processing method including acquiring first information from a detection device attached to a real object, acquiring second information from a display device, placing a virtual object corresponding to the first information and a virtual camera corresponding to the second information in a virtual space, and transmitting information on the virtual space to the display device.

Further, a third technique is an information processing program that causes a computer to execute an information processing method including acquiring first information from a detection device attached to a real object, acquiring second information from a display device, placing a virtual object corresponding to the first information and a virtual camera corresponding to the second information in a virtual space, and transmitting information on the virtual space to the display device.

### Advantageous Effects of Invention

According to the present technique, it is possible to display a virtual object without recognizing the position of a mark such as a marker. Note that the advantageous effect described here is not necessarily limited, and any advantageous effects described in the description may be enjoyed.

### BRIEF DESCRIPTION OF DRAWINGS

FIG. 1 is a block diagram illustrating a configuration of an information processing system according to an embodiment of the present technique.

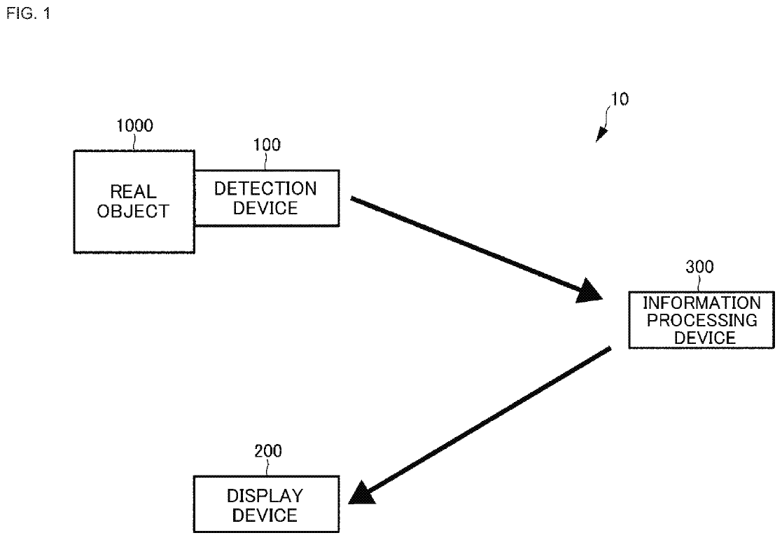

FIG. 2A is a block diagram illustrating a configuration of a detection device, and FIG. 2B is a block diagram illustrating a configuration of a display device.

FIG. 3 is an explanatory diagram of a visual field and a peripheral range.

FIG. 4 is a block diagram illustrating a configuration of an information processing device.

FIG. 5 is an explanatory diagram of arrangement of a virtual object and a virtual camera in a virtual space.

FIG. 6 is an explanatory diagram of arrangement position and arrangement attitude of a virtual object in a virtual space.

FIG. 7 is an explanatory diagram of position and attitude of the display device, and position and attitude of the virtual camera.

FIG. 8A is a stand signboard serving as a real object in a first specific embodiment, and FIG. 8B is a display example of a display device in the first specific embodiment.

FIG. 9A is a situation explanatory view of a second specific embodiment, and FIG. 9B is a display example of a display device in the second specific embodiment.

FIG. 10A is a second display example of the display device in the second specific embodiment, and FIG. 10B is a third display example of the display device in the second specific embodiment.

FIG. 11 is a schematic explanatory diagram of a third specific embodiment.

FIG. 12 is a display example of a display device in the third specific embodiment.

FIG. 13 is a diagram illustrating a modified example of the third specific embodiment.

FIG. 14A is a situation explanatory view of a fourth specific embodiment, and FIG. 14B is a display example of a display device in the fourth specific embodiment.

FIG. 15A is a situation explanatory view of a fifth specific embodiment, and FIG. 15B is a display example of a display device in the fifth specific embodiment.

### DESCRIPTION OF EMBODIMENTS

Hereinafter, embodiments of the present technique will be described with reference to the drawings. Note that the description will be given in the following order.

### <1. Embodiments>

### [1-1. Configuration of Information Processing System]

### [1-2. Configuration of Detection Device]

### [1-3. Configuration of Display Device]

### [1-4. Configuration of Information Processing Device]

### <2. Specific Embodiments>

### [2-1. First Specific Embodiment]

### [2-2. Second Specific Embodiment]

### [2-3. Third Specific Embodiment]

### [2-4. Fourth Specific Embodiment]

### [2-5. Fifth Specific Embodiment]

### [2-6. Other Specific Embodiments]

### <3. Modified Examples>

### 1. EMBODIMENTS

### 1-1. Configuration of Information Processing System

An information processing system 10 includes a detection device 100, a display device 200, and an information processing device 300, in which the detection device 100 and the information processing device 300 can communicate with each other via a network or the like, and the information processing device 300 and the display device 200 can communicate with each other via a network or the like.

The detection device 100 is attached to a real object 1000 in the real world, for example, a signboard, a sign, a fence, or the like, to use. Attachment of the detection device 100 to the real object 1000 is performed by a business operator who provides the information processing system 10, a business operator who uses the information processing system 10 to provide a service to a customer, a user who wants to show a CG video to another user with the information processing system 10, or the like.

The detection device 100 transmits to the information processing device 300 identification information for identifying the detection device 100 itself, and position information, attitude information, state information, and time information of the attached real object 1000. These pieces of information transmitted from the detection device 100 to the information processing device 300 correspond to first information recited in the claims. The time information is used for synchronization between the detection device 100 and the information processing device 300, confirmation of display timing, and the like. Details of the other pieces of information will be described below.

The display device 200 has at least a video display function of, for example, a smartphone or a head-mounted display, and an AR device or a VR device that is used by a user who uses the information processing system 10.

The display device 200 transmits to the information processing device 300 identification information of the display device 200 itself, and position information, attitude information, visual field information, peripheral range information, and time information of the display device 200. These pieces of information transmitted from the display device 200 to the information processing device 300 correspond to second information recited in the claims. The time information is used for synchronization between the display device 200 and the information processing device 300, confirmation of display timing, and the like. Details of the other pieces of information will be described below.

The information processing device 300 forms a virtual space, and places a virtual object 2000 in the virtual space according to the position information and attitude information of the detection device 100 transmitted from the detection device 100. The virtual object 2000 is created of CG of objects and living things existing in the real world, and is also created of CG of all things having any shape such as animated characters, letters, numbers, diagrams, images, and videos.

Further, the information processing device 300 places a virtual camera 3000 that virtually captures an image in the virtual space according to the position information and attitude information of the display device 200 transmitted from the display device 200. Then, information on the inside of the capture range of the virtual camera 3000 in the virtual space is transmitted to the display device 200.

The display device 200 renders and displays a CG video based on the information on the virtual space (hereinafter referred to as virtual space information, which will be described in detail below) transmitted from the information processing device 300. In a case where the display device 200 is an AR device, the CG video is overlaid and displayed on a video captured by a camera included in the AR device. Further, in a case where the display device 200 is a VII device, the created CG video and other CG videos as needed are synthesized and displayed. Further, in a case where the display device 200 is a transmissive AR device called smart glasses, the created CG video is displayed on its display unit.

### 1-2. Configuration of Detection Device

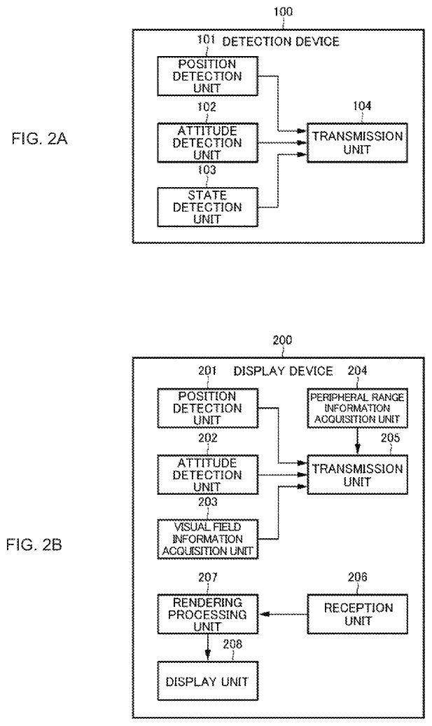

FIG. 2A is a block diagram illustrating a configuration of the detection device 100. The detection device 100 includes a position detection unit 101, an attitude detection unit 102, a state detection unit 103, and a transmission unit 104.

The position detection unit 101 detects the current position of the detection device 100 itself as position information by, for example, GPS (Global Positioning System). Since the detection device 100 is attached to the real object 1000, this position information can be said to represent the current position of the real object 1000. In addition to a point represented by coordinates (X, Y), the position information may include an altitude (Z) and point information suitable for use (building name, store name, floor number, road name, intersection name, address, map code, distance mark (km post), etc.).

Note that the method of detecting the position is not limited to GPS, and GNSS (Global Navigation Satellite System), INS (Inertial Navigation System), beacon, WiFi, geomagnetic sensor, depth camera, infrared sensor, ultrasonic sensor, barometer, radio wave detection device, or the like may be used, and these may be used in combination.

The attitude detection unit 102 detects an attitude of the detection device 100 to detect an attitude of the real object 1000 to which the detection device 100 is attached. The attitude is, for example, an orientation of the real object 1000, an upright state, an oblique state, or a sideways state of the real object 1000, or the like.

The state detection unit 103 detects a state of the real object 1000 to which the detection device 100 is attached. The state detection unit 103 detects at least a first state of the real object 1000 and a second state in which the first state is released. The first state and the second state of the real object 1000 referred to here are whether or not the real object 1000 is in a use state. The first state refers to a state in which the real object 1000 is in use, and the second state refers to a state in which the real object 1000 is not in use.

For example, for the real object 1000 being a stand signboard of a store, a state in which the real object 1000 is installed upright on the ground or on a stand is referred to as the first state in which it is in use, and a state in which the real object 1000 is placed sideways is referred to as the second state in which it is not in use. Further, for the real object 1000 being a hanging signboard of a store, a state in which the real object 1000 is hung on a wall is referred to as the first state in which it is in use, and a state in which the real object 1000 is placed sideways is referred to as the second state in which it is not in use. Furthermore, for the real object 1000 being a free standing fence, a state in which the real object 1000 is installed upright on the ground or on a stand is referred to as the first state in which it is in use, and a state in which the real object 1000 is placed sideways is referred to as the second state in which it is not in use. In this way, the first state and the second state differ depending on what the real object 1000 is.

The first state or the second state of the real object 1000 detected by the detection device 100 correspond to whether or not the information processing device 300 causes the virtual object 2000 to appear in the virtual space. When the real object 1000 is in the first state, the virtual object 2000 is placed in the virtual space and is displayed on the display device 200. Then, when the real object 1000 enters the second state in the state in which the virtual object 2000 is placed in the virtual space, the virtual object 2000 is deleted (not placed) from the virtual space. In this way, it is determined in advance that the first state and the second state each indicate in what state the real object 1000 is, and that the first state and the second state correspond to the placement and deletion of the virtual object 2000, respectively, or vice versa, and they are registered in the detection device 100 and the information processing device 300.

Such detection of the state of the real object 1000 may be automatically performed by static detection and attitude detection by an inertial measurement unit (IMU: Inertial Measurement Unit) or the like, or may be performed by a button-shaped sensor or the like that is pressed down by contacting with a supporting surface when the real object 1000 is installed.

The transmission unit 104 is a communication module that communicates with the information processing device 300 to transmit the first information, which includes the position information, the attitude information, the state information, and the time information, to the information processing device 300. Note that it is not always necessary to transmit all the pieces of information as the first information, and only a piece or pieces of necessary information may be transmitted. Communication with the information processing device 300 may be performed by a network such as the Internet or a wireless LAN such as Wi-Fi if the distance between the detection device 100 and the information processing device 300 is long, and may be performed by any one of wireless communication such as Bluetooth (registered trademark) or ZigBee and wired communication such as USB (Universal Serial Bus) communication if the distance between the detection device 100 and the information processing device 300 is short.

The detection device 100 continues to transmit the first information to the information processing device 300 at predetermined time intervals as long as the real object 1000 is in the first state. Then, when the real object 1000 enters the second state, the transmission of the first information ends.

### 1-3. Configuration of Display Device

FIG. 2B is a block diagram illustrating a configuration of the display device 200. The display device 200 includes a position detection unit 201, an attitude detection unit 202, a visual field information acquisition unit 203, a peripheral range information acquisition unit 204, a transmission unit 205, a reception unit 206, a rendering processing unit 207, and a display unit 208. The display device 200 is a smartphone serving as an AR device having a camera function and an image display function, a head-mounted display serving as a VR device, or the like.

The position detection unit 201 and the attitude detection unit 202 are similar to those included in the detection device 100, and detect the position and attitude of the display device 200, respectively.

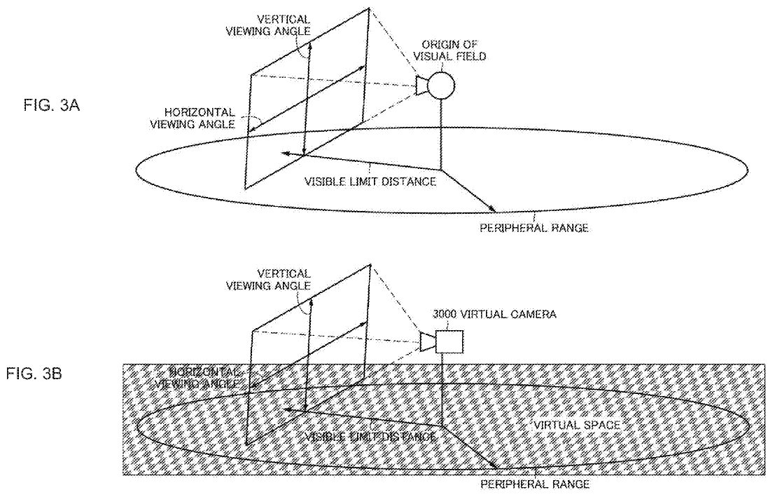

The visual field information acquisition unit 203 acquires a horizontal viewing angle, a vertical viewing angle, and a visible limit distance of display on the display unit 208. As illustrated in FIG. 3A, the visible limit distance indicates a limit distance that can be seen from the position of a line of sight of the user (the origin of the visual field). Further, the horizontal viewing angle is a horizontal distance at the position of the visible limit distance, and the vertical viewing angle is a vertical distance at the position of the visible limit distance. The horizontal viewing angle and the vertical viewing angle define a viewing range that is a range that the user can see.

In a case where the display device 200 is an AR device having a camera function, the horizontal view angle, the vertical view angle, and the visible limit distance, which are visual field information, are determined by the camera settings. Further, in a case where the display device 200 is a VR device, the horizontal viewing angle, the vertical viewing angle, and the visible limit distance are set to predetermined values in advance depending on that device. As illustrated in FIG. 3B, the vertical viewing angle, the horizontal viewing angle, and the visible limit distance of the virtual camera 3000 placed in the virtual space are set to be the same as the horizontal viewing angle, the vertical viewing angle, and the visible limit distance of display on the display unit 208.

The peripheral range information acquisition unit 204 acquires information indicating a peripheral range. The peripheral range is a range of a predetermined size with the position of a viewpoint of the user who sees a video on the display device 200 (the origin of the visual field) as almost the center, as illustrated in FIG. 3A. The peripheral range is set in advance in a manner that is defined in advance by the provider of a service using the information processing system 10 or is defined by the user. The peripheral range information corresponds to information on a predetermined range in the virtual space, recited in the claims.

As illustrated in FIG. 3B, the display device 200 receives from the information processing device 300 information on a virtual space within the same range as the peripheral range with the virtual camera 3000 placed in the virtual space formed by the information processing device 300 as almost the center.

The visible limit distance and the peripheral range are distances in the virtual space, and all distances in the virtual space may be defined to be the same as the distances in the real world so that 1 m in the virtual space is defined to be the same as 1 m in the real world. However, distances in the virtual space do not have to be the same as the distances in the real world. In that case, it is necessary to define such that “one meter in the virtual space corresponds to ten meters in the real world”. Further, distances in the virtual space may be defined by pixels. In that case, it is necessary to define such that “one pixel in the virtual space corresponds to one centimeter in the real world”.

The transmission unit 205 is a communication module that communicates with the information processing device 300 to transmit position information, attitude information, visual field information, peripheral range information, and time information, to the information processing device 300. These pieces of information transmitted from the display device 200 to the information processing device 300 correspond to second information recited in the claims. Note that it is not always necessary to transmit all the pieces of information as the second information, and only a piece or pieces of necessary information may be transmitted.

Communication with the information processing device 300 may be performed by a network such as the Internet or a wireless LAN such as Wi-Fi if the distance between the display device 200 and the information processing device 300 is long, and may be performed by any one of wireless communication such as Bluetooth (registered trademark) or ZigBee and wired communication such as USB communication if the distance between the display device 200 and the information processing device 300 is short.

The reception unit 206 is a communication module for communicating with the information processing device 300 to receive the virtual space information. The received virtual space information is supplied to the rendering processing unit 207.

The virtual space information includes visual field information of the virtual camera 3000 determined from the horizontal viewing field angle, vertical viewing field angle, and visible limit distance of the virtual camera 3000, and information on the inside of the peripheral range. The visual field information of the virtual camera 3000 indicates a range which is presented to the user as a video on the display device 200.

The rendering processing unit 207 performs rendering processing based on the virtual space information received from the information processing device 300, thereby creating a CG video to be displayed on the display unit 208 of the display device 200.

The display unit 208 is a display device including, for example, an LCD (Liquid Crystal Display), a PDP (Plasma Display Panel), or an organic EL (Electro Luminescence) panel. The display unit 208 displays the CG video created by the rendering processing unit 207, a user interface serving as an AR device or a VR device, and the like.

When the display device 200 enters a mode in which the information processing system 10 is used (e.g., a service application using the information processing system 10 is activated), the display device 200 continuously transmits the second information, which includes the identification information, the position information, the attitude information, and the visual field information, the peripheral range information, and the time information to the information processing device 300 at predetermined time intervals. Then, the display device 200 ends the transmission of the second information when the mode of using the information processing system 10 ends.

### 1-4. Configuration of Information Processing Device

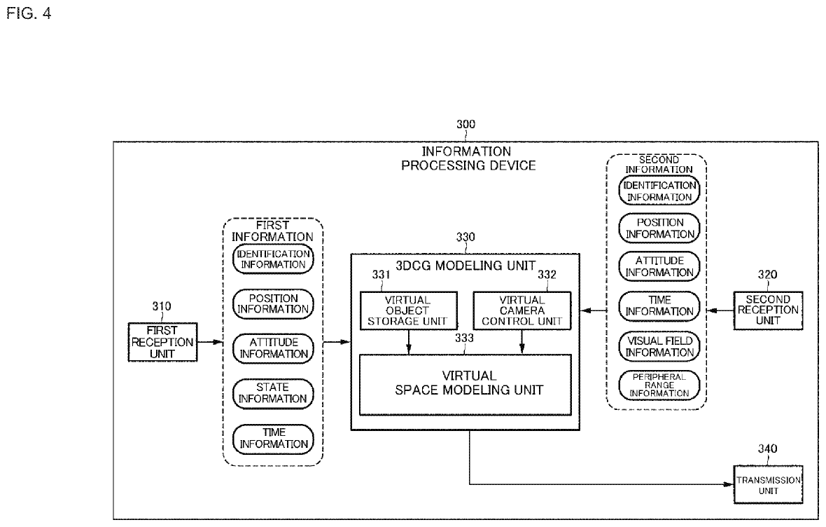

FIG. 4 is a block diagram illustrating a configuration of the information processing device 300. The information processing device 300 includes a first reception unit 310, a second reception unit 320, a 3DCG modeling unit 330, and a transmission unit 340. The 3DCG modeling unit 330 includes a virtual object storage unit 331, a virtual camera control unit 332, and a virtual space modeling unit 333.

The first reception unit 310 is a communication module for communicating with the detection device 100 to receive the first information transmitted from the detection device 100. The first information from the detection device 100 is supplied to the 3DCG modeling unit 330.

The second reception unit 320 is a communication module for communicating with the display device 200 to receive the second information transmitted from the display device 200. The second information from the display device 200 is supplied to the 3DCG modeling unit 330.

The 3DCG modeling unit 330 includes a DSP (Digital Signal Processor) or a CPU (Central Processing Unit), a RAM (Random Access Memory), a ROM (Read Only Memory), and the like. The ROM stores programs to loaded and operated by the CPU. The RAM is used as a work memory for the CPU. The CPU performs various processing in accordance with the programs stored in the ROM to issue commands, thereby performing processing as the 3DCG modeling unit 330.

The virtual object storage unit 331 stores data (shape, color, size, etc.) data that defines the virtual object 2000 created in advance. If pieces of data on a plurality of virtual objects are stored in the virtual object storage unit 331, each virtual object 2000 has a unique ID. Associating this ID with the identification information of the detection device 100 makes it possible to place the virtual object 2000 corresponding to the detection device 100 in the virtual space.

The virtual camera control unit 332 performs controls such as changing or adjusting the position, attitude, and viewing range of the virtual camera 3000 in the virtual space. Note that in a case where a plurality of virtual cameras 3000 are used, it is necessary to give a unique ID to each virtual camera 3000. Associating this ID with the identification information of the display device 200 makes it possible to place the virtual camera 3000 corresponding to each display device 200 in the virtual space.

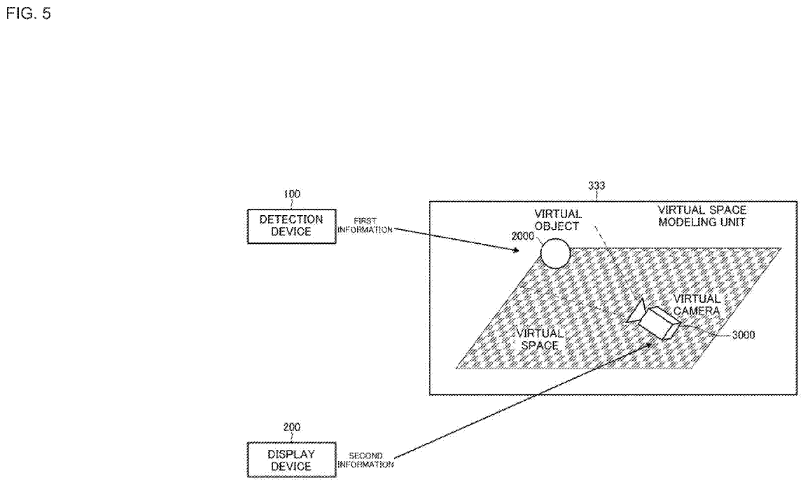

The virtual space modeling unit 333 performs modeling processing of the virtual space. When the state information included in the first information supplied from the detection device 100 is the first state corresponding to the positioning of the virtual object 2000, the virtual space modeling unit 333 reads from the virtual object storage unit 331 the virtual object 2000 having the ID corresponding to the identification information of the detection device 100, and places it in the virtual space as illustrated in FIG. 5. At that time, the virtual object 2000 is placed in a position in the virtual space corresponding to the position information transmitted from the detection device 100.

This position in the virtual space corresponding to the position information may be a position having the same coordinates in the virtual space as the coordinates of the position of the detection device 100 (the position of the real object 1000), or may be a position at a predetermined distance from the position of the detection device 100 (the position of the real object 1000) serving as a reference. At what position the placement is made based on the position information of the virtual object 1000 may be defined in advance. If it is not defined, the virtual object 1000 may be placed in a default position indicated by the position information. Further, the virtual object 2000 is placed in the virtual space in an attitude corresponding to the attitude information transmitted from the detection device 100.

When receiving the identification information, the position information, and the attitude information from the display device 200, the virtual space modeling unit 333 further places the virtual camera 3000 having the ID corresponding to the identification information in the virtual space. At that time, the virtual camera 3000 is placed in a position in the virtual space corresponding to the position information transmitted from the display device 200. Similar to the placement of the virtual object 2000 described above, the virtual camera 3000 may be placed in a position having the same coordinates in the virtual space as the coordinates of the display device 200, or may be placed in a position at a predetermined distance from the display device 200 serving as a reference. Further, the virtual camera 3000 is placed in the virtual space in an attitude corresponding to the attitude information from the display device 200.

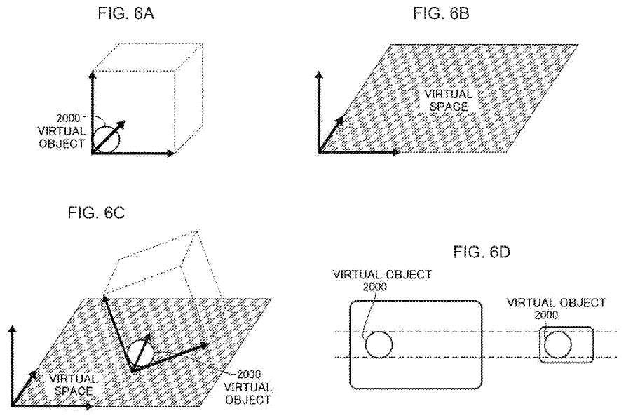

As illustrated in FIG. 6A, the virtual space is a 3D stereoscopic space model designed in advance. The world coordinate system is defined in the virtual space, so that the position and attitude in the space can be uniquely expressed by using that system. Further, the virtual space may include settings that affect the entire environment, such as definitions of the ambient light and also the sky and floor.

The virtual object 2000 is object data of a 3D model designed in advance, and unique identification information (ID) is given to each virtual object 2000. As illustrated in FIG. 6B, a unique local coordinate system is defined for each virtual object 2000, and the position of the virtual object 2000 is represented as a position from the base point of the local coordinate system.

As illustrated in FIG. 6C, when the virtual object 2000 is placed in the virtual space, the position and attitude of the local coordinate system including the virtual object 2000 changes based on the received position information and attitude information. Further, when the attitude information is updated, the virtual object 2000 is rotated about the base point of the local coordinate system. Furthermore, when the position information is updated, the base point of the local coordinate system is moved to the corresponding coordinates on the world coordinate system of the virtual space.

Note that if it is necessary to display the created CG video in actual size, even when the same virtual object 2000 is displayed as illustrated in FIG. 6D, it is necessary to display a larger range for a large screen and a smaller range for a small screen. This viewing range can be specified by the visual field information transmitted from the display device 200 to the information processing device 300. The display device 200 can transmit appropriate visual field information to the information processing device 300 according to the screen size of the display unit and the characteristics of the camera, thereby adjusting the size of the virtual object 2000 to be displayed to the actual size.

Associating the identification information of the display device 200 with the ID of the virtual camera 3000 in advance makes it possible to place, in a case where a plurality of display devices 200 are used at the same time, a plurality of virtual cameras 3000 corresponding to the plurality of display devices 200, respectively, in the virtual space.

Furthermore, when receiving the visual field information from the display device 200, the virtual camera control unit 332 adjusts the horizontal viewing angle, the vertical viewing angle, and the visible limit distance of the virtual camera 3000 according to the visual field information. Furthermore, when receiving the peripheral range information from the display device 200, the virtual camera control unit 332 sets a peripheral range preset in the display device 200 in the virtual space.

The display device 200 constantly transmits the position information and the attitude information to the information processing device 300 at predetermined intervals, and the virtual camera control unit 332 changes the position, orientation, and attitude of the virtual camera 3000 in the virtual space according to changes of the position, orientation, and attitude of the display device 200.

When the virtual object 2000 and the virtual camera 3000 are placed in the virtual space, the 3DCG modeling unit 330 provides to the transmission unit 340 the virtual space information, which is information on the inside of the visual field of the virtual camera 3000 in the virtual space specified by the horizontal viewing angle, the vertical viewing angle, and the visible limit distance, and information on the inside of the peripheral range in the virtual space.

The transmission unit 340 is a communication module for communicating with the display device 200 to transmit the virtual space information supplied from the 3DCG modeling unit 330 to the display device 200. Note that although the first reception unit 310, the second reception unit 320, and the transmission unit 340 are described as separate units in the block diagram of FIG. 4, one communication module having a transmitting and receiving function may involve the first reception unit 310, the second reception unit 320, and the transmission unit 340.

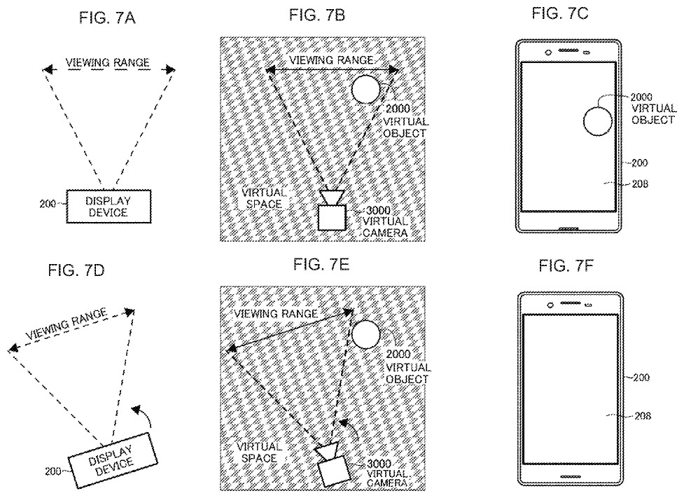

When the display device 200 receives the virtual space information from the information processing device 300, the rendering processing unit 207 performs rendering processing based on the virtual space information to create a CG video and display the CG video on the display unit 208. When the position and attitude of the display device 200 in the real world are as illustrated in FIG. 7A, the virtual camera 3000 is placed in the virtual space corresponding to the position and attitude of the display device 200 as illustrated in FIG. 7B. Then, when the virtual object 2000 is within the viewing range of the virtual camera 3000, the virtual object 2000 is displayed on the display unit 208 of the display device 200 as illustrated in FIG. 7C.

When the position and/or attitude of the display device 200 changes from the state of FIG. 7A as illustrated in FIG. 7D, the position and/or attitude of the virtual camera 3000 in the virtual space also correspondingly changes as illustrated in FIG. 7E. Then, as illustrated in FIG. 7E, when the virtual object 2000 deviates from the viewing range of the virtual camera 3000, the virtual object 2000 is no longer displayed on the display unit 208 of the display device 200 as illustrated in FIG. 7F.

When the virtual object 2000 enters the viewing range of the virtual camera 3000 again from the state where the virtual object 2000 deviates from the viewing range of the virtual camera 3000 as illustrated in FIGS. 7D to 7F, the virtual object 2000 is displayed on the display unit 208 of the display device 200. Accordingly, the user who uses the display device 200 needs to adjust the position and attitude of the display device 200 in order to display the virtual object 2000 on the display unit 208. However, in the present technique, the user does not need to recognize the position of the detection device 100 in order to display the virtual object 2000 on the display device 200, and also capture the detection device 100.

Note that when the state information indicating that the real object 1000 is in the second state is received from the detection device 100, the 3DCG modeling unit 330 deletes the virtual object 2000 from the virtual space.

Note that the peripheral range is set as a fixed range in advance, but when information indicating that the peripheral range information has changed is received from the display device 200, the virtual camera control unit 332 changes the peripheral range in the virtual space.

As described above, the display device 200 creates a CG video by performing the rendering processing based on the virtual space information received from the information processing device 300. Then, in a case where the display device 200 is an AR device, the CG video is overlaid and displayed on a video captured by a camera included in the AR device. Further, in a case where the display device 200 is a VR device, the created CG video and other CG videos as needed are synthesized and displayed. Further, in a case where the display device 200 is a transmissive AR device called smart glasses, the created CG video is displayed on its display unit.

The detection device 100, the display device 200, and the information processing device 300 are configured as described above. Note that the information processing device 300 is configured to operate in, for example, a server of a company that provides the information processing system 10.

The information processing device 300 is implemented by a program, and the program may be installed in advance on a processor such as a DSP or on a computer that performs signal processing, or may be distributed by downloading, a storage medium, or the like, to be installed by the user himself/herself. Further, the information processing device 300 may be implemented not only by a program but also by combining a dedicated device, a circuit, or the like with hardware having the functions.

In the conventional AR technique, the user marker needs to continue capturing an AR marker in order to display a created CG video on the AR device, and this causes a problem that when the AR marker deviates from the capture range of the camera, the virtual object 2000 suddenly disappears. On the other hand, in the present technique, the user does not need to capture the real object 1000 to which the detection device 100 is attached in order to display a created CG video on the display device 200 or to know the position of the real object 1000. Therefore, there is no problem that the virtual object 2000 is not displayed and cannot be seen because the real object 1000 to which the detection device 100 is attached cannot be captured by the camera, or the camera deviates from the real object 1000 during the display of the virtual object 2000 and thus the virtual object 2000 disappears.

In the conventional AR technique, a virtual object 2000 is displayed and appears at the moment when the user changes the orientation of the camera to captures the marker. The surrounding environment such as a shadow and a sound that should always be present if the virtual object 2000 exists is not present until the virtual object 2000 appears. On the other hand, in the present technique, the virtual object 2000 exists as long as it is placed in the virtual space even if it is not visible because it is not displayed on the display device 200. Therefore, it is possible to provide the surrounding environment such as a shadow of the virtual object 2000 to the user even in a state where the virtual object 2000 is not displayed on the display device 200.

Further, in a conventional method of associating positioning information of a virtual object with map data, when the positioning of a real object in the real world changes, the positioning information of the virtual object on the map data also needs to be changed accordingly. On the other hand, in the present technique, when the real object 1000 to which the detection device 100 is attached is moved, the positioning information of the virtual object is changed accordingly. Since the information processing device 300 and the display device 200 do not need to change any information, they are easy to use.

### 2. SPECIFIC EMBODIMENTS

### 2-1. First Specific Embodiment

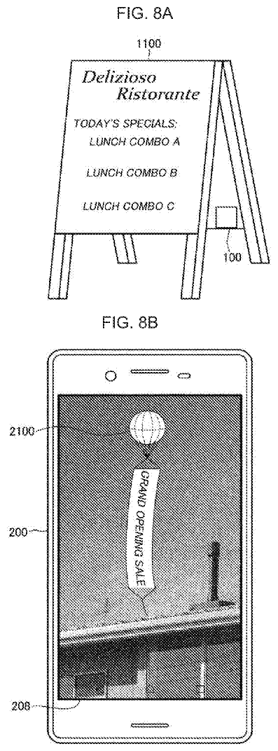

Next, a first specific embodiment of the information processing system 10 will be described with reference to FIG. 8. The first specific embodiment is to display on an AR device such as a smartphone of the user a virtual balloon 2100 that is a virtual object to be a commercial advertisement according to the installation of a standing signboard 1100 of a store. In this first specific embodiment, the AR device corresponds to the display device 200.

In the first specific embodiment, prior to the use of the information processing system 10, a staff member of the store attaches the detection device 100 to the stand signboard 1100 of the store as illustrated in FIG. 8A. Then, a state in which the standing signboard 1100 is installed upright is set in advance as a first state in which the virtual balloon 2100, which is a virtual object, appears in a virtual space, and a state in which the standing signboard 1100 is removed and laid down sideways is set as a second state in which the virtual balloon 2100 is deleted from the virtual space. This is registered in the information processing device 300.

Further, the virtual object storage unit 331 of the information processing device 300 stores in advance data of the virtual balloon 2100 associated with the identification information of the detection device 100 attached to the standing signboard 1100.

Then, when a staff member of the store sets the standing signboard 1100 to which the detection device 100 is attached to the installed state which is the first state, the first information, which includes the identification information, the position information, the state information, and the time information is transmitted from the detection device 100 to the information processing device 300.

When the state information received from the detection device 100 indicates the first state in which the virtual object appears in the virtual space, the 3DCG modeling unit 330 of the information processing device 300 reads the virtual balloon 2100 which is the virtual object corresponding to the identification information from the object storage unit 331. Then, the virtual space modeling unit 33 places the virtual balloon 2100 in the virtual space.

On the other hand, when the user who uses the display device 200, which is the AR device, sets the display device 200 to an AR use mode, the display device 200 transmits the identification information, the position information, the attitude information, the visual field information, the peripheral range information, and the time information to the information processing device 300.

The virtual camera control unit 332 of the information processing device 300 places the virtual camera 3000 in the virtual space based on the received position information and attitude information of the display device 200. Further, the horizontal viewing angle, vertical viewing angle, and visible limit distance of the virtual camera 3000 are set based on the visual field information. Furthermore, the peripheral range in the virtual space is set based on the peripheral range information.

Then, when the user changes the position and attitude of the display device 200, the virtual camera control unit 332 changes the position and attitude of the virtual camera 3000 in the virtual space accordingly. The virtual space information on the inside of the capture range defined by the horizontal vertical viewing angle and vertical viewing angle of the virtual camera 3000 is always transmitted to the display device 200 as long as the display device 200 is in the AR use mode.

The virtual space information, which includes information on the inside of the viewing range of the virtual camera 3000 and information on the inside of the peripheral range, is always transmitted from the information processing device 300 to the display device 200. Therefore, when the virtual balloon 2100, which is the virtual object 2000, enters the viewing range of the virtual camera 3000, the rendering processing unit 207 of the display device 200 renders the virtual balloon 2100 to create it as a CG video. Then, as illustrated in FIG. 8B, it is overlaid and displayed on a live image on the display unit 208 of the display device 200.

According to this first specific embodiment, it is possible to provide an impressive commercial advertisement similar to a balloon set up without actually setting up the balloon in the real world. Further, the user who uses the AR device serving as the display device 200 can see the virtual balloon 2100 on display of the display device 200 even when the user does not know the position of the signboard to which the detection device 100 is attached and the signboard is not visible.

Further, since the virtual balloon 2100, which is a virtual object, is not actually set up, the virtual balloon 2100 can be visually recognized even in bad weather such as rain or snow or in poor visibility conditions such as a dark time period. Further, a staff member of the store can carry out advertising by just placing the signboard as usual for business operations without needing to understand the mechanism of this technique and also being aware of using the technique.

Note that, for example, for a store in a large shopping mall, the detection device 100 can be installed on the ceiling of the shopping mall, or can be hung from the ceiling. Then, in the virtual space, a character, a banner, or the like is placed as the virtual object 2000. As a result, the character floating in the air or the banner hanging from the ceiling is displayed on the AR device serving as the display device 200.

Note that the standing signboard 1100 and the virtual balloon 2100 used in this first specific embodiment are merely examples, and the present technique is not limited to those applications. For the purpose of “promotion of a store”, the real object 1000 may be a hanging signboard, a flag, a placard, or the like, and the virtual object 2000 may be a doll, a banner, a signboard, or the like.

### 2-2. Second Specific Embodiment

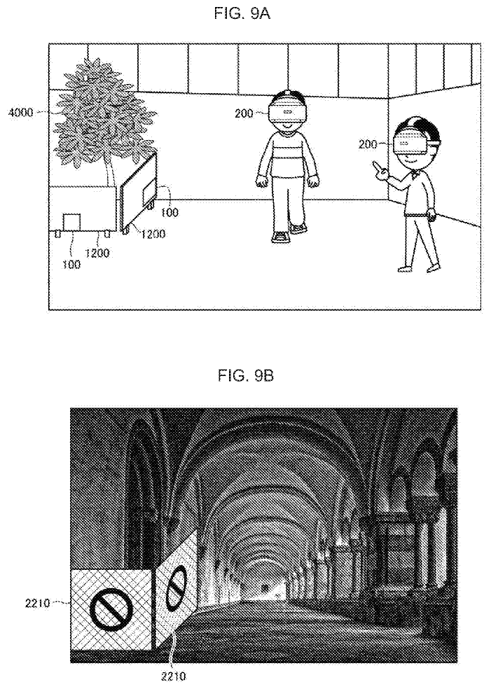

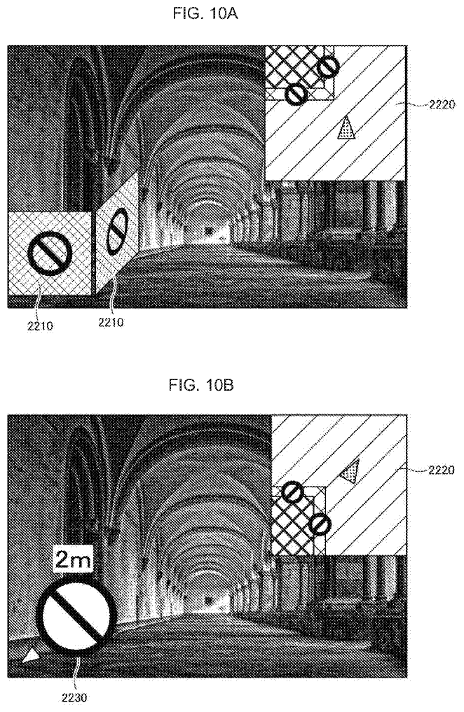

Next, a second specific embodiment of the information processing system 10 will be described with reference to FIGS. 9 and 10. In the second specific embodiment, as illustrated in FIG. 9A, in a VII attraction in which a user wearing a head-mounted display walks around in a certain space such as a room, an icon or the like indicating an obstacle 4000 in the space is displayed on the head-mounted display of the user. FIG. 9A illustrates a state of users participating in the VR attraction, not a video viewed by a user participating in the VR attraction. In this second specific embodiment, the head-mounted display serving as a VII device corresponds to the display device 200.

In the second specific embodiment, a fence 1200 installed in front of the obstacle 4000 in a VR attraction facility is a real object, and the information processing system 10 is used for the purpose of preventing the user from approaching the obstacle 4000.

Prior to the use of the information processing system 10, a staff member of the VR attraction attaches the detection device 100 to the fence 1200. This fence 1200 is for preventing the user from approaching the obstacle 4000 in the VR attraction facility.

Then, a state in which the fence 1200 is installed upright is set in advance as a first state in which an entry prohibition icon 2210 that is a virtual object appears in a virtual space, and a state in which the fence 1200 is removed and laid down sideways is set as a second state in which the entry prohibition icon 2210 is deleted from the virtual space. This is registered in the information processing device 300.

Further, the virtual object storage unit 331 of the information processing device 300 stores in advance data of the entry prohibition icon 2210 associated with the identification information of the detection device 100 attached to the fence 1200.

Then, when a staff member of the VR attraction sets the fence 1200 to which the detection device 100 is attached to the installed state which is the first state, the first information, which includes the identification information, the position information, the state information, and the time information is transmitted from the detection device 100 to the information processing device 300.

When the state information received from the detection device 100 indicates the first state in which the virtual object appears in the virtual space, the 3DCG modeling unit 330 of the information processing device 300 reads the entry prohibition icon 2210 which is the virtual object corresponding to the identification information of the detection device 100 from the object storage unit 331. Then, the virtual space modeling unit 333 places the entry prohibition icon 2210 in the virtual space.

On the other hand, when the user who uses the display device 200, which is the head-mounted display, sets the display device 200 to a VR use mode, the display device 200 transmits the identification information, the position information, the attitude information, the visual field information, the peripheral range information, and the time information to the information processing device 300.

The virtual camera control unit 332 of the information processing device 300 places the virtual camera 3000 in the virtual space based on the received position information and attitude information of the display device 200. Further, the horizontal viewing angle, vertical viewing angle, and visible limit distance of the virtual camera 3000 are set based on the visual field information. Furthermore, the peripheral range in the virtual space is set based on the peripheral range information.

Then, when the user changes the position and attitude of the display device 200, the virtual camera control unit 332 changes the position and attitude of the virtual camera 3000 in the virtual space accordingly.

The information on the inside of the viewing range of the virtual camera 3000 and the inside of the peripheral range is transmitted from the information processing device 300 to the display device 200 at predetermined time intervals as long as the display device 200 is in the VR use mode. Accordingly, when the entry prohibition icon 2210, which is a virtual object, enters the viewing range of the virtual camera 3000, the entry prohibition icon 2210 is rendered by the rendering processing unit 207 of the display device 200 and displayed on the display device 200 as illustrated in FIG. 9B.

The head-mounted display used in the VR attraction normally completely covers the user's field of view, and the user can only see a video displayed on the display unit of the head-mounted display. Accordingly, the user cannot visually recognize the fence 1200, which is a real object installed in the VR attraction facility. However, according to this second specific embodiment, the entry prohibition icon 2210 is displayed at a position corresponding to the fence 1200 of the real object in a display video of the head-mounted display, so that the user can recognize the presence of the fence 1200, that is, a position where the user should not approach.

Further, in the present technique, the virtual space information includes not only the visual field information but also the information on the peripheral range. Accordingly, even when the virtual object is not in the viewing range in the virtual space but is in the peripheral range, the position information or the like of the virtual object is transmitted to the display device 200 as the virtual space information. Accordingly, using the virtual space information makes it possible to display on the display device 200 serving as the head-mounted display a map-like image (hereinafter, referred to as a map image 2220) that notifies the user of the position of the fence 1200 as illustrated in FIG. 10B even if the fence 1200 is installed in the VR attraction in a direction in which the user's face does not face.

In a display example of FIG. 10A, the map image 2220 as looking down on the inside of the VR attraction facility from above is overlaid on a CG video for VR attraction displayed on the display device 200.

Displayed in this map image 2220 are an icon indicating position and orientation of the user obtained from the position information and the attitude information, which are included in the second information from the display device 200, and an icon indicating the position of the fence 1200 to which the detection device 100 is attached. As a result, even when the user who enjoys the VR attraction does not face the fence 1200, it is possible to notify the user of the position of the fence 1200 and thus ensure the safety of the user.

Further, as illustrated in FIG. 10B, when the user wearing the head-mounted display serving as the display device 200 approaches the fence 1200 to which the detection device 100 is attached, a direction in which the fence 1200 is present and an icon 2230 indicating a distance to the fence 1200 may be displayed on the display device 200. Furthermore, a warning sound may be output by using a voice output function of the display device 200. Note that such warning may be provided by lighting and/or vibration, instead of or in addition to display and/or sound.

Note that although the fence 1200 is exemplified as a real object and the entry prohibition icon 2210 is exemplified as a virtual object in this second specific embodiment, the real object 1000 and the virtual object 2000 which are available in the VR attraction are not limited thereto.

For example, when a video of a VR attraction is a video of a world covered with ice, a crack of ice, a cliff of ice, a waterfall, or the like is displayed as a virtual object in front of the position where the fence 1200 is placed. Displaying a video related to a video displayed as a world of VR attraction as a virtual object in this way makes it possible to make an impression such as “cannot go ahead” or “should not approach” on the user without destroying the world view of the video and provide a warning.

### 2-3. Third Specific Embodiment

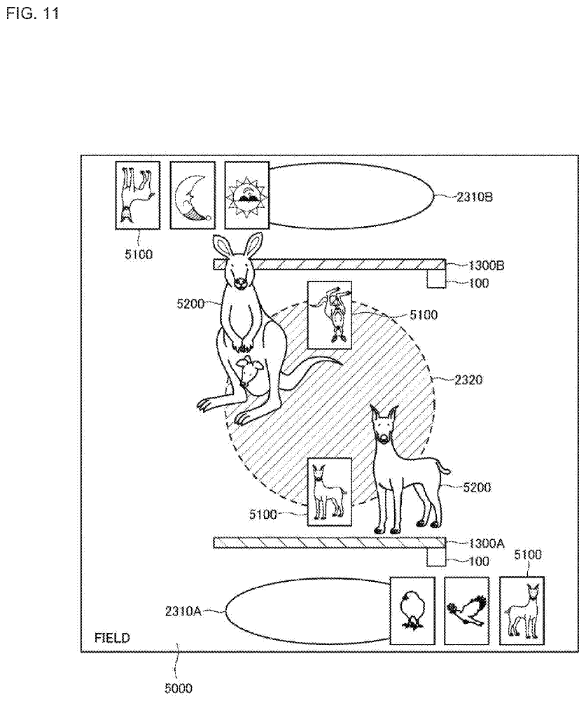

Next, a third specific embodiment of the information processing device 300 will be described with reference to FIGS. 11 to 13. The third specific embodiment is an example in which a game is played using an AR device such as a smartphone. For example, the game is a battle game using AR characters played in a space having a certain size such as a plaza or a park. Displaying cards, items, characters, and the like used for the game on the AR device makes it possible to provide a realistically and visually interesting game. In this third specific embodiment, a smartphone or the like serving as an AR device corresponds to the display device 200.

In this game, an area (own area, enemy area) is defined for each user, and items, characters, and the like owned by the user of the area are arranged in each area. Further, a play area that is a place where characters owned by the user compete with each other is also defined.

In order to define the area of each user and the play area, information is required that includes position and overall size of a real world place (hereinafter referred to as a field 5000) used in the game, the number of users, an ID of each user, and position and orientation of the area of each user. In this third specific embodiment, using the detection device 100 makes it possible to easily define the area of each user and the play area.

First, the user prepares markers 1300 that are as many real objects as the number of users who participate in the game, and attaches the detection devices 100 having different identification information to all the markers 1300. This marker 1300 may be anything as long as it is directly visible to the user, such as a rod-shaped object.

Then, for a one-to-one battle system, two markers 1300 (1300A and 1300B) are arranged in the field 5000 so as to face each other as illustrated in FIG. 11. In this third specific embodiment, the first state, which is a state of the marker 1300 being a real object in use, refers to a state of being placed in contact with the ground, and the second state, which is a state of the marker 1300 not being in use, refers to a state of leaning against a wall. As a result, the marker 1300 continuously transmits the first information to the information processing device 300 at fixed time intervals after the marker 1300 is installed on the ground.

Note that the detection device 100 can detect a direction (azimuth, etc.) in which the detection device 100 faces, that is, a direction in which the marker 1300 faces, by using a geomagnetic sensor or the like. The information processing device 300 can determine whether or not the two markers 1300A and 1300B face each other based on the direction in which the marker 1300 faces and the position information of the marker 1300.

The information processing device 300 stores in the virtual object storage unit 331 an icon (user area icon 2310) indicating a user area corresponding to the identification information of the detection device 100 attached to each marker 1300 in advance, and an icon (play area icon 2320) indicating a play area. For example, the user area icon 2310 and the play area icon 2320 are each a circular icon that represents the range of the corresponding area. Each user area icon 2310 and the play area icon 2320 are distinguishable from each other by different colors.

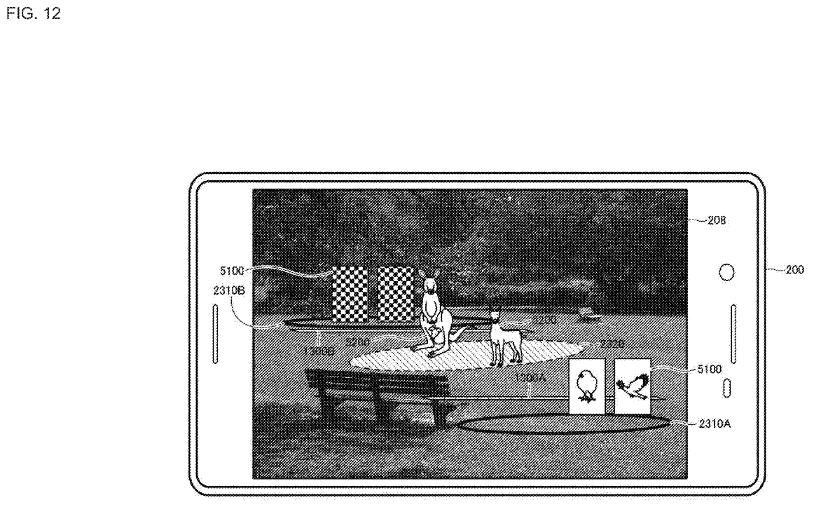

Then, the 3DCG modeling unit 330 of the information processing device 300 places the play area icon 2320, which is a virtual object, in a region between the two detection devices 100 facing each other in a virtual space. Furthermore, the user area icons 2310 (2310A and 2310B), which are virtual objects, are placed in regions opposite to the play area with respect to the respective detection devices 100. As a result, when the user area icons 2310A and 2310B and the play area icon 2320 enter the viewing range in the virtual space, those icons are overlaid and displayed on a live image on the display device 200. The user can visually recognize each of the user area icons 2310A and 2310B and the play area icon 2320 as illustrated in FIG. 12 by looking at the display unit 208 of the display device 200. In a display example of FIG. 12, in addition to the user area icons 2310A and 2310B and the play area icon 2320, game cards 5100 and characters 5200 are displayed. The cards 5100 in the user area icon 2310A are face up for the user who is give the marker 1300, and the cards 5100 in the user area icon 2310B are face down. This depends on the orientation of the detection device 100.

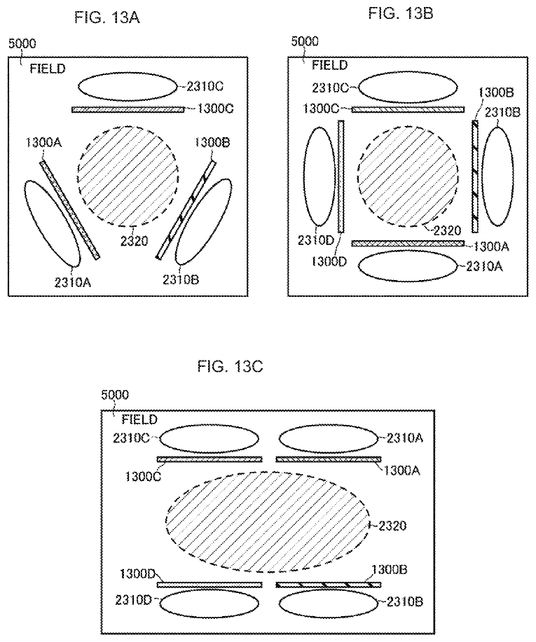

FIG. 11 illustrates an example in which two users face each other, but the number of users and the arrangement of the user areas and the play area are not limited thereto. As illustrated in FIG. 13A, markers 1300A, 1300B, and 1300C that are real objects may be arranged so that three users face each other in a triangle. In FIG. 13A, user area icons 2310A, 2310B, 2310C, which are virtual objects, and a play area icon 2320 are arranged accordingly.

As illustrated in FIG. 13B, markers 1300A, 1300B, 1300C, and 1300D, which are real objects, may be arranged so that four users face each other in a square shape. In FIG. 13B, user area icons 2310A, 2310B, 2310C, and 2310D, which are virtual objects, and a play area icon 2320 are arranged accordingly.

Furthermore, as illustrated in FIG. 13C, markers 1300A, 1300B, 1300C, and 1300D, which are real objects, may be arranged so that four users are located with two users facing the other two users. In FIG. 13C, user area icons 2310A, 2310B, 2310C, and 2310D, which are virtual objects, and a play area icon 2320 are arranged accordingly. Since the detection device 100 can detect the position information and the attitude information, the information processing device 300 can recognizes how the markers 1300 are arranged and how they face each other, based on the position information and the attitude information, and place the user area icons 2310 and the play area icon 2320, which are virtual objects 2000, in the virtual space.

Note that each marker 1300 is not limited to a rod shape, and may have any shape such as a circular coin shape or a cube shape. Further, the markers 1300 do not necessarily need to be installed facing each other, and for example, two markers 1300 may be installed and a rectangular area with these markers being located diagonally may be set as a play area.

Further, the field 5000, which is a place used for the game, may be outdoors such as a park, indoors such as a room, or on a desk.

As described above, the information processing device 300 can determine whether the plurality of markers 1300 to each of which the detection device 100 is attached are installed facing each other. Therefore, when it is not possible to detect that the markers 1300 face each other for a predetermined time, or when the state where the markers 1300 face each other is released but the first information is continuously transmitted from the detection device 100, a warning may be provided that encourages the user(s) to arrange the markers 1300 in the correct positions.

### 2-4. Fourth Specific Embodiment

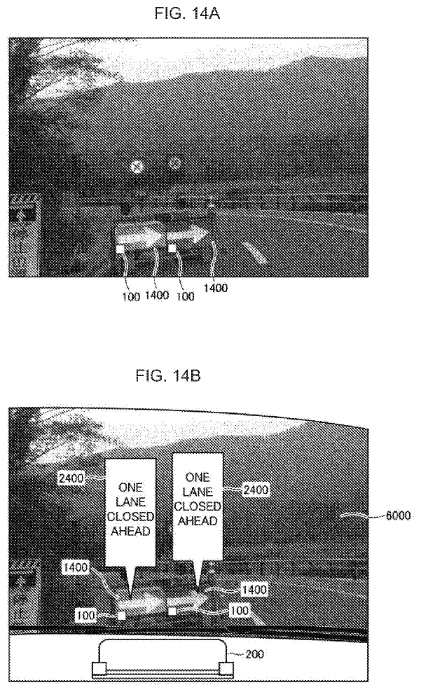

Next, a fourth specific embodiment of the information processing device 300 will be described with reference to FIG. 14. In the fourth specific embodiment, a sign (hereinafter, referred to as a virtual sign 2400) that is a virtual object is displayed on the display device 200 of the user for a sign installed that is a real object (hereinafter, referred to as a real object sign 1400) and indicates road construction. In this fourth specific embodiment, the display device 200 will be described as a head-up display used in a vehicle. It is assumed that the display device 200, which is the head-up display, is provided on a front panel of the vehicle driven by the user, and projects a video on a windshield 6000. The user who is driving can obtain various information while driving by seeing the video projected on the windshield 6000.

In the fourth specific embodiment, prior to the use of the information processing system 10, a worker who performs road construction attaches the detection device 100 to the real object sign 1400. Then, a state in which the real object sign 1400 is installed upright is set in advance as a first state in which the virtual sign 2400, which is a virtual object, appears in a virtual space, and a state in which the real object sign 1400 is removed and laid down sideways is set as a second state in which the virtual sign 2400 is deleted from the virtual space. This is registered in the information processing device 300.

Further, the virtual object storage unit 331 of the information processing device 300 stores in advance data of the virtual sign 2400 associated with the identification information of the detection device 100 attached to the real object sign 1400.

Then, when a worker of the road construction sets the real object sign 1400 to which the detection device 100 is attached to the installed state which is the first state, the first information, which includes the identification information, the position information, the state information, and the time information is transmitted from the detection device 100 to the information processing device 300.

When the state information received from the detection device 100 indicates the first state in which the virtual object appears in the virtual space, the 3DCG modeling unit 330 of the information processing device 300 reads the virtual sign 2400 which is the virtual object corresponding to the identification information from the object storage unit 331. Then, the virtual space modeling unit 333 places the virtual sign 2400 in the virtual space.

When the user sets the head-mounted display serving as the display device 200 to a use mode, the display device 200 transmits to the information processing device 300 the second information, which includes the identification information, the position information, the attitude information, the visual field information, the peripheral range information, and the time information.

The virtual camera control unit 332 of the information processing device 300 places the virtual camera 3000 in the virtual space based on the received position information and attitude information of the display device 200. Further, the horizontal viewing angle, vertical viewing angle, and visible limit distance of the virtual camera 3000 are set based on the visual field information. Furthermore, the peripheral range in the virtual space is set based on the peripheral range information.

The virtual space information, which includes the information on the inside of the viewing range of the virtual camera 3000 and the inside of the peripheral range, is always transmitted from the information processing device 300 to the display device 200. Accordingly, when the vehicle approaches the construction site and then the virtual sign 2400 enters the viewing range of the virtual camera 3000, the rendering processing unit 207 of the display device 200 renders the virtual sign 2400 and the display device 200 displays the virtual sign 2400 as illustrated in FIG. 14B.

According to this fourth specific embodiment, for example, making the virtual sign 2400 larger than the real object sign 1400 enables the virtual sign 2400 to be seen from a distance, so that such a virtual sign 2400 certainly urges the user driving the vehicle to exercise caution. Further, since the virtual sign 2400 is not a sign that is actually installed at the construction site, the virtual sign 2400 can be visually recognized by the user who is driving even in bad weather such as rain or snow or in poor visibility conditions such as a dark road.

Note that when the road construction is completed and a worker removes the real object sign 1400 to which the detection device 100 is attached, the state information indicating the second state is transmitted from the detection device 100 to the information processing device 300, and the information processing device 300 deletes the virtual sign 2400 from the virtual space. As a result, even when the user's vehicle approaches the construction site, the virtual sign 2400 is not displayed on the head-up display.

Further, since the position information of the detection device 100, that is, the position information of the real object sign 1400 is transmitted from the detection device 100 to the information processing device 300, transferring the position information from the information processing device 300 to a car navigation system makes it possible to display information on the construction site on a map displayed by the navigation system.

Note that although the display device 200 is described above as a head-up display, the display device 200 may be a VR device such as a head-mounted display or an AR device such as a smartphone.

### 2-5. Fifth Specific Embodiment

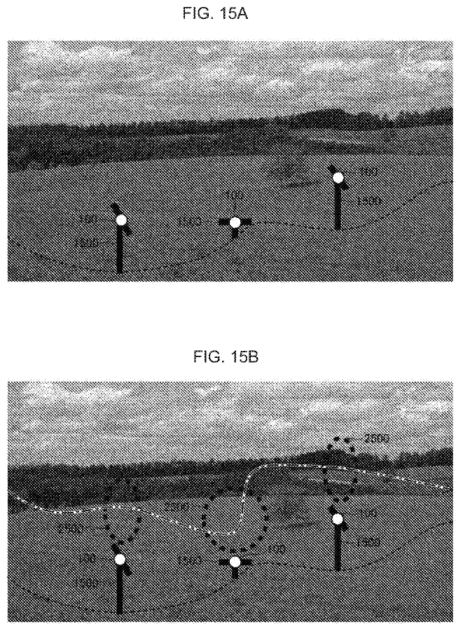

Next, a fifth specific embodiment of the information processing device 300 will be described with reference to FIG. 15. In the fifth specific embodiment, rings (hereinafter, referred to as virtual rings 2500) that are virtual objects indicating a course of a race using a drone that is a flying object (hereinafter, referred to as drone race) are displayed on the display device 200. Displaying the virtual rings 2500 makes it possible to present the course of the drone race to the user who is a drone pilot. In the drone race, each drone flies so as to pass through the virtual rings 2500. In this fifth specific embodiment, the display device 200 will be described as an AR head-mounted display. The head-mounted display for AR synthesizes a virtual video with an outside scene on its transmissive display unit, so that the user can see both the real world scene and the virtual objects 2000 of CG at the same time. Participants in the drone race wear head-mounted displays for AR to control their respective drones.

In the fifth specific embodiment, prior to the use of the information processing system 10, an operating staff member of the drone race (hereinafter referred to as staff member) attaches the detection device 100 to each of poles 1500 indicating a course. As each pole 1500, as illustrated in FIG. 15, a pole having a substantially T-shape is used so that its height and direction can be seen. Note that when the detection device 100 detects the height of the pole 1500 with a distance measurement sensor such as LIDAR (Laser Imaging Detection and Ranging), the detection device 100 needs to be provided on the top of the pole 1500. Note that the height of the pole 1500 may be detected by any method. For example, for the pole 1500 being extendable and retractable, the height of the pole 1500 may be detected by measuring the extended length.

In the fifth specific embodiment, height information of the detection device 100 is also transmitted from the detection device 100 as the first information. The information processing device 300 places each virtual ring 2500 at a height corresponding to the height information in a virtual space. The virtual ring 2500 may be placed in the virtual space, for example, 1 m above the height of the detection device 100 indicated by the height information. This is because if the virtual ring 2500 is placed at the height of the detection device 100, the drone may come into contact with the pole 1500.

Then, a state in which the pole 1500 is installed upright is set in advance as a first state in which the virtual ring 2500, which is a virtual object, appears in the virtual space, and a state in which the pole 1500 is removed and laid down sideways is set as a second state in which the virtual ring 2500 is deleted from the virtual space. This is registered in the information processing device 300.

Further, the virtual object storage unit 331 of the information processing device 300 stores in advance data of the virtual ring 2500 associated with the identification information of the detection device 100 attached to the pole 1500.

Then, when a staff member sets the pole 1500 to which the detection device 100 is attached to the installed state which is the first state, the first information, which includes the identification information, the position information, the state information, and the time information is transmitted from the detection device 100 to the information processing device 300. Note that as illustrated in FIG. 15A, the staff member sets poles 1500 at predetermined intervals along the route from the start of the course to the goal.

Further, in the drone race, since the order in which each drone passes through the virtual rings 2500 is also determined, the detection device 100 needs to be associated with order information indicating the arrangement order of the virtual rings 2500 from the start position to the goal position, in addition to the identification information.

When the state information received from the detection device 100 indicates the first state in which the virtual object appears in the virtual space, the 3DCG modeling unit 330 of the information processing device 300 reads the virtual ring 2500 corresponding to the identification information from the object storage unit 331. Then, the virtual space modeling unit 333 places the virtual ring 2500 in the virtual space.

Each detection device 100 has unique identification information, and the virtual ring 2500 that is the virtual object 2000 corresponding to the identification information is placed. Accordingly, the same number of virtual rings 2500 as the detection devices 100 are placed in the virtual space.

When the user sets the head-mounted display for AR serving as the display device 200 to a use mode, the head-mounted display for AR transmits to the information processing device 300 the identification information, the position information, the attitude information, the visual field information, the peripheral range information, and the time information.

The virtual camera control unit 332 of the information processing device 300 places the virtual camera 3000 in the virtual space based on the received position information and attitude information of the display device 200. Further, the horizontal viewing angle, vertical viewing angle, and visible limit distance of the virtual camera 3000 are set based on the visual field information. Furthermore, the peripheral range in the virtual space is set based on the peripheral range information.

The information on the inside of the viewing range of the virtual camera 3000 and the inside of the peripheral range is always transmitted from the information processing device 300 to the display device 200. Accordingly, when the virtual ring 2500 enters the viewing range of the virtual camera 3000, the rendering processing unit 207 of the display device 200 renders the virtual ring 2500 and the display device 200 displays the virtual ring 2500 as illustrated in FIG. 15B.

Since the detection device 100 detects the attitude information as well as the position information of the pole 1500, it is possible to change the orientation of the virtual ring 2500 by changing the orientation of the pole 1500, thereby changing the layout of the course.

According to this fifth specific embodiment, it is possible to set the course of a drone race without labor, cost, and the like of installing the virtual rings 2500 which is the real object 1000 at the drone racing venue. Further, the virtual ring 2500 placed in the virtual space can be used for recording the time when each drone passes and for producing an effect such as turning on a real illumination at the timing when the drone passes the virtual ring 2500. Further, it can also be used for determining a drone's course out.

Since the position of the virtual ring 2500, which is the virtual object 2000, can be specified by the pole 1500, which is the real object 1000, when the position and orientation of the virtual ring 2500 are changed to change the layout of the course, the position and attitude of the corresponding pole 1500 are just changed.

Note that the virtual ring 2500 may be left in the virtual space even if the corresponding pole 1500 is removed after the virtual ring 2500 is placed in the virtual space. In such a case, the course can be set by sequentially placing the virtual rings 2500 using one pole 1500.

Note that although the display device 200 is described above as a head-up display for AR, the display device 200 may be a VR device such as a head-mounted display or an AR device such as a smartphone. In a case where the display device 200 is a VII device such as a head-mounted display, the drone pilot of the drone racing wears a head-mounted display for VII to control the drone. The pilot wearing the head-mounted display for VII can simultaneously see both a real world scene captured by a camera mounted on the drone and the virtual object 2000 of CG. In this case, the virtual camera control unit 332 of the information processing device 300 places the virtual camera 3000 based on received position information of the drone, so that the attitude of the virtual camera 3000 is set in an orientation defined by the attitude information of the display device 200 in addition to received attitude information of the drone.

This fifth specific embodiment is not limited to drone racing, but is also applicable to auto racing, athletics such as marathons, water competitions such as boat racing and ship racing, ice competitions such as skating, and mountain competitions such as skiing and mountaineering.

In the application to such racing, it is possible to display routes and display virtual competitors based on records of past race results. Further, for an activity with a danger such as mountain climbing, the real object 1000 to which the detection device 100 is attached presents a route, and therefore, it can be used for confirmation of the moving route in getting lost.

### 2-6. Other Specific Embodiments

Hereinafter, other specific embodiments will be described.

The detection device 100 is attached to a vehicle serving as the real object 1000, and a marker which is a sign serving as the virtual object 2000 is placed in a virtual space. As a result, the marker indicating the position of the vehicle is displayed on an AR device serving as the display device 200. This is useful, for example, to find the vehicle from among many vehicles in a parking lot by the user himself/herself.

Further, at an event venue or the like, the detection device 100 is attached to a placard for route guidance serving as the real object 1000, and a character is placed as a virtual object 2000 in a virtual space. As a result, the character is displayed on an AR device serving as the display device 200, so that the character can give a guidance instruction and the like. Further, information such as taxiway display and the last position of a line can be provided to the user.

Further, the detection device 100 is attached to a marker serving as the real object 1000, the marker is installed in a space such as a room or a conference room, and furniture, chairs, desks, and the like are placed as virtual objects 2000 in a virtual space. As a result, furniture or the like is displayed on an AR device serving as a display device 200, so that the layout of the room can be confirmed without actually arranging the furniture or the like in the room.

Further, the detection device 100 is attached to each piece of a board game which is the real object 1000, and a plurality of characters serving as virtual objects 2000 corresponding to the respective pieces are placed in a virtual space. As a result, in an AR device serving as the display device 200, the character for each piece is displayed at the position of the piece. In addition, it is possible to perform processing for the board game or perform an effect by changing a character in accordance with a change in the position of the piece or a change in the state of the piece (e.g., turning over).

### 3. MODIFIED EXAMPLES

Although the embodiments of the present technique are specifically described above, the present technique is not limited to the above-described embodiments, and various modifications are possible based on the technical idea of the present technique.

In the embodiments, what is displayed on the display device 200 is described as a video, but what is displayed may be an image. Further, in addition to displaying a video/image, or separately from an image/video, anything other than the video/image such as a sound may be output when the virtual object 2000 enters the viewing range of the virtual camera 3000.

The display device 200 may perform all the functions of the information processing device 300, so that the display device 200 receives information from the detection device 100 to perform processing.

In the description of the embodiments, one virtual object is placed corresponding to one detection device 100 in a virtual space, but one detection device 100 may correspond to a plurality of virtual objects. This is useful, for example, for a case where the same virtual objects are placed but only one detection device 100 is required.

Further, in the embodiments, a state in which the real object 1000 is in use is referred to as the first state in which the virtual object is placed in a virtual space, and a state in which the real object 1000 is not in use is referred to as the second state in which the virtual object is not placed in the virtual space. However, the first state may refer to a state in which the real object 1000 is not in use, and the second state may refer to a state in which the real object 1000 is in use. For example, when the information processing system 10 is used to notify that a store is closed, the virtual object may be displayed when a standing signboard or the like, which is the real object 1000, is not in use.

Further, although the information processing device 300 includes the virtual object storage unit 331 in the embodiments, the display device 200 may include the virtual object storage unit 331. In that case, the information processing device 300 transmits to the display device 200 specific information for specifying the virtual object 2000 corresponding to the identification information transmitted from the detection device 100. Then, the display device 200 reads data of the virtual object 2000 corresponding to the specific information from the virtual object storage unit 331 and performs rendering. As a result, the virtual object 2000 corresponding to the identification information of the detection device 100 can be displayed on the display device 200 as in the embodiments.

The present technique may also be configured as follows.

(1)

An information processing device that acquires first information from a detection device attached to a real object,

acquires second information from a display device, places a virtual object corresponding to the first information and a virtual camera corresponding to the second information in a virtual space, and transmits information on the virtual space to the display device.

(2)

The information processing device according to (1), wherein the first information is state information of the real object, and the virtual object is placed in the virtual space when the real object is in the first state.

(3)

The information processing device according to (1) or (2), wherein in a state in which the real object is placed in the virtual space, the virtual object is not placed in the virtual space when the real object is in the second state.

(4)

The information processing device according to any one of (1) to (3), wherein the first information is position information of the real object, and the virtual object is placed in a position within the virtual space corresponding to a position of the detection device.

(5)

The information processing device according to any one of (1) to (4), wherein the first information is identification information of the detection device, and the virtual object associated with the identification information in advance is placed in the virtual space.

(6)

The information processing device according to any one of (1) to (5), wherein the first information is attitude information of the real object, and the virtual object is placed in the virtual space in an attitude corresponding to the attitude information.

(7)

The information processing device according to any one of (1) to (6), wherein the second information is position information of the display device, and the virtual camera is placed in a position within the virtual space corresponding to the position information.

(8)

The information processing device according to any one of (1) to (7), wherein the second information is attitude information of the display device, and the virtual camera is placed in the virtual space in an attitude corresponding to the attitude information.

(9)

The information processing device according to any one of (1) to (9), wherein the second information is visual field information of the display device, and a visual field of the virtual camera is set according to the visual field information.

(10)

The information processing device according to (9), wherein the information on the virtual space is information on an inside of the visual field of the virtual camera set according to the visual field information of the display device.

(11)

The information processing device according to any one of (1) to (10), wherein the information on the virtual space is information on an inside of a predetermined range in the virtual space.

(12)

The information processing device according to (11), wherein the predetermined range is determined in advance in the display device, and is a range with an origin of the visual field as almost a center.

(13)

An information processing method including acquiring first information from a detection device attached to a real object;

acquiring second information from a display device;

placing a virtual object corresponding to the first information and a virtual camera corresponding to the second information in a virtual space; and transmitting information on the virtual space to the display device.

(14)

An information processing program that causes a computer to execute an information processing method including acquiring first information from a detection device attached to a real object;

acquiring second information from a display device;

placing a virtual object corresponding to the first information and a virtual camera corresponding to the second information in a virtual space; and transmitting information on the virtual space to the display device.

### REFERENCE SIGNS LIST

100 Detection device
200 Display device
300 Information processing device
1000 Real object
2000 Virtual object
3000 Virtual camera

1. An information processing device that acquires first information from a detection device attached to a real object,
acquires second information from a display device,
places a virtual object corresponding to the first information and a virtual camera corresponding to the second information in a virtual space, and transmits information on the virtual space to the display device.

2. The information processing device according to claim 1, wherein the first information is state information of the real object, and the virtual object is placed in the virtual space when the real object is in a first state.

3. The information processing device according to claim 1, wherein in a state in which the real object is placed in the virtual space, the virtual object is not placed in the virtual space when the real object is in the second state.

4. The information processing device according to claim 1, wherein the first information is position information of the real object, and the virtual object is placed at a position within the virtual space corresponding to a position of the detection device.

5. The information processing device according to claim 1, wherein the first information is identification information of the detection device, and the virtual object associated with the identification information in advance is placed in the virtual space.

6. The information processing device according to claim 1, wherein the first information is attitude information of the real object, and the virtual object is placed in the virtual space in an attitude corresponding to the attitude information.

7. The information processing device according to claim 1, wherein the second information is position information of the display device, and the virtual camera is placed at a position within the virtual space corresponding to the position information.

8. The information processing device according to claim 1, wherein the second information is attitude information of the display device, and the virtual camera is placed in the virtual space in an attitude corresponding to the attitude information.

9. The information processing device according to claim 1, wherein the second information is visual field information of the display device, and a visual field of the virtual camera is set according to the visual field information.

10. The information processing device according to claim 9, wherein the information on the virtual space is information on an inside of the visual field of the virtual camera set according to the visual field information of the display device.

11. The information processing device according to claim 1, wherein the information on the virtual space is information on an inside of a predetermined range in the virtual space.

12. The information processing device according to claim 11, wherein the predetermined range is determined in advance in the display device, and is a range with an origin of the visual field as almost a center.

13. An information processing method comprising:
acquiring first information from a detection device attached to a real object;
acquiring second information from a display device;
placing a virtual object corresponding to the first information and a virtual camera corresponding to the second information in a virtual space; and transmitting information on the virtual space to the display device.

14. An information processing program that causes a computer to execute an information processing method including acquiring first information from a detection device attached to a real object;
acquiring second information from a display device;
placing a virtual object corresponding to the first information and a virtual camera corresponding to the second information in a virtual space; and transmitting information on the virtual space to the display device.
